(19) United States
(12) Patent Application Publication
(10) Pub. No.: US 2012/0248393 A1
(43) Pub. Date: Oct. 4, 2012

(54) Air Jack

(76) Inventors: Jean D. Moore, Moreno Valley, CA (US); Lakeycha Moore, Moreno Valley, CA (US)

(21) Appl. No.: 13/433,833

(22) Filed: Mar. 29, 2012

Related U.S. Application Data
(60) Provisional application No. 61/468,883, filed on Mar. 29, 2011.

(51) Int. Cl. B66F 3/35

(52) U.S. Cl. 254/93 HP

(57) ABSTRACT

The invention provides a motor vehicle jack for easily lifting a vehicle to change a tire. The motor vehicle jack of the present invention has two substantially circular air bags or chambers, a lower air bag and an upper air bag coupled together by a substantially cylindrical connector. The upper air bag couples to a substantially cylindrical top having a top surface with a steel plate. The lower air bag couples to a substantially cylindrical base. A hose having a first and second end, couples the base to an air pump. The air pump receives power from a cigarette lighter or auxiliary power from the vehicle for inflating the air bags and simultaneously lifting the desired corner of the vehicle.

### CLAIM OF PRIORITY

This patent application claims priority under 35 USC 119(e) (1) from U.S. Provisional Patent Application Ser. No. 61/468,883 filed Mar. 29, 2011, of common inventorship herewith entitled, “Air Jacker.”

### FIELD OF THE INVENTION

The present invention relate to the field of automobile accessory tools, and more specifically to a motor-vehicle jack which employs an air pump to inflate a plurality of air chambers and raise the vehicle to aid in changing a flat or blown-out tire.

### BACKGROUND OF THE INVENTION

Sooner or later all automobile operators must deal with changing a flat tire on the side of the road. While a flat or blown-out tire is certainly a matter of inconvenience, the simple act of changing a tire can eave motorists stressed and exhausted, soiled and sweaty. The first requirement for changing a tire is to properly operate the jack to lift the car off of the ground. Last year, nearly four million motorists requested roadside assistance to change a flat tire. Clearly, there is a need for a better car jack, one that can lift a vehicle without any strenuous effort on the use's behalf, and operable by virtually anyone in such a predicament.

The motor vehicle jack of the present invention resolves the foregoing issues by providing an easy to use automobile jack for changing a vehicle tire. The motor vehicle jack described herein is suitable for general consumers, including elderly, teenagers, and back pain sufferers.

The prior art has put forth several devices and designs for air-aided elevating of a vehicle to aid in changing a tire. Among these are:

U.S. Pat. No. 4,560,145 to Stanley W. Widmer describes an air bag jack comprising an inflatable member describing a plurality of annular sections forming an essentially pyramidal shape enabling the sections to collapse into one another.

U.S. Pat. No. 5,441,237 to Charles F. Sweeney describes a pneumatic vehicle jack including a plurality of stacked pneumatic bags wherein the bags are arranged for selective inflation by use of a pneumatic compressor.

U.S. Pat. No. 7,063,307 to Andrew Williams describes a system and structure comprising an integrated vehicle lift system comprising a rigid orthogonally telescoping housing including a plurality of jacks each having a telescoping interconnected cylinders containing a valve sealed expandable plenum within the housing.

None of these references describe the present invention.

### SUMMARY OF THE INVENTION

It is an object of the present invention to provide a motor vehicle jack which enables users to change a flat tire without requiring lifting a vehicle by means of a standard hand operated car jack.

It is a further object of the present invention to provide a motor vehicle jack which relieves the stress and frustration caused by changing a vehicle tire.

It is a still further object of the present invention to provide a motor vehicle jack which is easy to use for motorists of all ages.

It is a still further object of the present invention to provide a motor vehicle jack which makes changing a tire easy for those who lack physical strength needed to use a standard hand jack.

It is a still further object of the present invention to provide a motor vehicle jack which reduces the time required to change a tire.

It is a still further object of the present invention to provide a motor vehicle jack which does not cause the user to break a sweat and thus soil their clothing when changing a vehicle tire.

It is a still further object of the present invention to provide a motor vehicle jack which saves the user considerable time and money on roadside assistance services.

It is a still further object of the present invention to provide a motor vehicle jack which is inexpensive to manufacture.

The present invention provides a motor vehicle jack for easily lifting a vehicle to change a tire. The motor vehicle jack of the present invention has two substantially circular air bags or chambers, a lower air bag and an upper air bag coupled together by a substantially cylindrical connector. The upper air bag couples to a substantially cylindrical top having a top surface with a steel plate. The lower air bag couples to a substantially cylindrical base. A hose having a first and second end, couples the base to an air pump. The air pump receives power from a cigarette lighter or auxiliary power from the vehicle for inflating the air bags and simultaneously lifting the desired corner of the vehicle.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

FIG. 1 is a diagrammatic perspective view of the motor vehicle jack of the present invention illustrating a plurality of air bags coupled to an air pump by a hose.

FIG. 2 is a diagrammatic perspective view of the motor vehicle jack of the present invention in a non-inflated position ready for use with a vehicle.

FIG. 3 is a diagrammatic perspective view of the motor vehicle jack of the present invention in an inflated position lifting a corner of a vehicle.

### DETAILED DESCRIPTION OF THE INVENTION

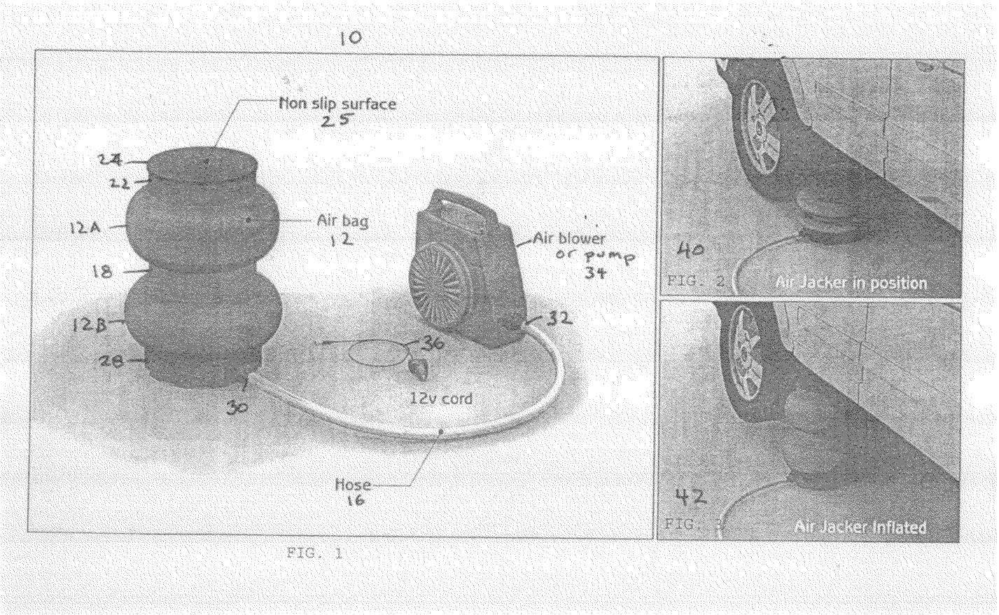

FIG. 1 illustrates the motor vehicle jack 10 of the present invention for easily lifting a corner of a vehicle to change a tire. In its broadest context, the motor vehicle jack 10 has a plurality of air bags 12 coupled to an air pump 14 via a hose 16.

The motor vehicle jack 10 provides a safe and easy to use automotive accessory for changing a flat or blown out tire. The motor vehicle jack 10 has a plurality of air bags 12. Preferably, two air bags 12, an upper air bag 12A and a lower air bag 12B, which are stacked atop another with a connector 18 located therebetween. The air bags 12 are substantially circular when not inflated and inflate into a flattened sphere when air is pumped into them. Preferably, the air bags 12 are made of any suitable material, such as high-tech, high-durability, composite material. The connector 18 is substantially cylindrical and allows air to flow freely between the lower air bag 12B and upper air bag 12A.

The upper air bag 12A has an upper edge 20 which couples to a top 22. The top 22 is substantially cylindrical and similar in size and shape to the connector 18. The top 22 of the upper air bag 12A has a top surface 24 which aligns with the vehicle when positioned for use. Preferably, the top surface 24 has a steel plate 25, made of non-slip material such that the motor vehicle jack 10 is securely positioned against the vehicle when raising the vehicle before changing a tire.

The lower air bag 12B has a bottom edge 26 which couples to a base 28. The base 28 is substantially cylindrical in shape and similar in size and shape to the connector 18 and top 22, thereby creating a symmetrical motor vehicle jack 10. A hose 16, having a first end 30 and a second end 32 couples the base 28 to an air pump 34. The first end 30 of the hose 16 couples to the base 28 and allows air to flow into the base 28. Preferably, the hose 16 is a braided steel hose as is known in the art.

The motor vehicle jack 10 has a non-inflated position 40 and an inflated position 42. In the non-inflated position 40, the air bags 12 are substantially flat to allow for easy storage of the motor vehicle jack 10 within the vehicle. In the inflated position 42, air flows through the hose 16 into the base 28 and then upwardly into the lower air bag 12B, connector 18, upper air bag 12 and finally reaches the top 22, thereby inflating the air bags 12 of the motor vehicle jack 10. When inflated, the motor vehicle jack 10 stands approximately three feet in height. Therefore, the motor vehicle jack 10 lifts the vehicle approximately three feet from the ground surface for easily changing a tire.

The second end 32 of the hose 16 couples to an air pump 34. The air pump 34 is similar to air pumps well known in the art for directed compressed air into the hose. Preferably, the air pump 34 receives power from a power adapter 36 which inserts into a vehicle's cigarette lighter or auxiliary power. Alternatively, the air pump 34 has a rechargeable battery (not shown) for storing power. The power adapter 16 allows a motorist to easily and effectively use the motor vehicle jack 10 using the power generated by the vehicle. This saves time and money as the motorist is not dependent on roadside assistance.

FIG. 2 illustrates the motor vehicle jack 10 underneath a vehicle ready for use. Preferably, the motor vehicle jack 10 is positionable in the non-inflated position 40 near the flat or blown-out tire to allow the top surface 24 to align and engage with the bottom surface of the vehicle.

FIG. 3 illustrates the motor vehicle jack 10 in use, lifting a vehicle. The motor vehicle jack 10 is in the inflated position 42 which raises the vehicle for easily changing a flat or blown out tire.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A motor vehicle jack device comprising a plurality of air bags, which are stacked atop another to form a lower air bag and an upper air bag with a connector located therebetween, wherein the air bags are substantially circular when not inflated and inflate into a flattened sphere when air is pumped into them, and wherein the connector is substantially cylindrical and allows air to flow freely between the lower air bag and the upper air bag, and further comprising an air pump and hose for inflating the air bags.

2. The motor vehicle jack device of claim 1 further comprising an upper edge on upper air bag which couples to a top, wherein the top is substantially cylindrical and similar in size and shape to the connector, and wherein the top of the upper air bag has a top surface which aligns and engages with a lower edge of a vehicle when positioned for use.

3. The motor vehicle jack device of claim 2 wherein the top surface has a steel plate made of non-slip material such that the motor vehicle jack is securely positioned against the vehicle when raising the vehicle before changing a tire.

4. The motor vehicle jack device of claim 2 wherein the lower air bag has a bottom edge which couples to a base, wherein the base is substantially cylindrical in shape and similar in size and shape to the connector and top, thereby creating a symmetrical motor vehicle jack.

5. The motor vehicle jack device of claim 4 further comprising a hose, having a first end and a second end and couples the base to an air pump wherein the first end of the hose couples to the base and allows air to flow into the base.

6. The motor vehicle jack device of claim 5, wherein the hose is a braided steel hose.

7. The motor vehicle jack device of claim 5 wherein the motor vehicle jack has a non-inflated position and an inflated position, and when the device is in the non-inflated position, the air bags are substantially flat to allow for easy storage of the motor vehicle jack within the vehicle.

8. The motor vehicle jack device of claim 7, and when the device is in the inflated position, air flows through the hose into the base and then upwardly into the lower air bag, connector, upper air bag and finally reaches the top, thereby inflating the air bags of the motor vehicle jack, thereby lifting the vehicle from the ground surface for easily changing a tire.

9. The motor vehicle jack device of claim 5 wherein the second end of the hose couples to an air pump.

10. The motor vehicle jack device of claim 5 wherein the air pump receives power from a power adapter which inserts into a vehicle's cigarette lighter or auxiliary power.
